(19) United States
(12) Patent Application Publication
(10) Pub. No.: US 2025/0286355 A1
(43) Pub. Date: Sep. 11, 2025

(54) JOINT SLIDING LEVER LINK TYPE WIRE CLIP WITH OPENING/CLOSING OPERATION GRIP GUIDE FUNCTION FOR INDIRECT LIVE WIRE AND WIRE FIXING METHOD USING SAME

(71) Applicants: DAEWON ELECTRIC CO.,LTD., Cheongju-si (KR); DAEWON INDUSTRY COMPANY, Jeungpyeong-gun (KR)

(72) Inventor: Sae Won KWON, Jeungpyeong-gun (KR)

(21) Appl. No.: 19/214,990

(22) Filed: May 21, 2025

Related U.S. Application Data
(63) Continuation of application No. PCT/KR2023/018617, filed on Nov. 20, 2023.

(30) Foreign Application Priority Data
Dec. 12, 2022 (KR) 10-2022-0172332

(51) Int. Cl. H02G 1/02; F16G 11/10

(52) U.S. Cl. CPC H02G 1/02; F16G 11/10

(57) ABSTRACT

Provided is a wire clip capable of gripping and fixing the electric wire of a distribution line via an indirect live wire work. An indirect live work is carried out using a stick for indirect live work while a sufficient safe distance from the wire is secured, so that the opening of a gripper and the gripping operation of the wire proportional to the magnitude of tension can be conveniently carried out, durability can be improved due to the improvement of an operation structure and the opening operation of the gripper can be carried out with less effort, and when gripping and fixing the wire, a rotational movement is prevented by a fixed support gripper and stabilized gripping and fixing operations of the wire can be enabled in proportional to the magnitude of the tension.

### TECHNICAL FIELD

The present invention relates to a wire clip configured to fixedly grip a wire of a distribution line through indirect live wire work, and more particularly to a joint sliding lever link-type wire clip having an opening/closing operation grip guide function for indirect live wire work, configured to be coupled to a wire grip so as to fixedly grip, through indirection live wire work, a wire using a stick for indirect live wire work, to be openable and closable with minimal force by using a joint sliding method, to prevent, after the wire is fixedly gripped, rotational movement of the wire clip when tension is generated in the wire, and to stably grip and fix the wire in proportion to the magnitude of tension of the wire, and a wire fixing method using the same.

### BACKGROUND ART

In general, live wire work refers to line work conducted in a state in which power transmission is continuously performed through a power line. Meanwhile, since the risk of safety incidents is significantly high during live wire work, live wire work is conducted only when it is difficult to cut off power. More specifically, when it is difficult to stop operation of transmission and distribution facilities and the like, live wire work is conducted by a trained worker. Here, the trained worker is required to use insulating protective equipment or protective equipment.

Live wire work on a power line includes inspection, repair, replacement, and cleaning of a wire component such as a suspension insulator. Live wire work may be divided into direct live wire work and indirect live wire work. Indirect live wire work is a method of conducting live wire work indirectly using an insulating tool such as a stick. Although indirect live wire work is safe, there is a disadvantage of being labor intensive.

In addition, direct live wire work is performed in such a manner that a worker wears insulated gloves in an insulated bucket and works in direct contact with an electric wire in a live wire state. While direct live wire work is simple and reduces working time, there is a disadvantage in that the worker is exposed to a high risk of electric shock, which often causes serious injury.

As safety management on industrial sites has been strengthened, Korea Electric Power Corporation (KEPCO) abolished direct live wire work in 2016. Accordingly, overseas import of tools for indirect live wire work has increased, and research and development has been actively conducted on the tools for indirect live wire work.

Meanwhile, utilization of a wire grip is high in various types of live wire work. The wire grip is a device configured to pull or release, during live wire work, a wire in order to obtain an appropriate dip of the wire. Accordingly, in order to perform indirect live wire work, the wire grip serves as a very important device.

An example of such a wire grip is disclosed in Korean Patent No. 10-1179056 and Korean Utility Model No. 20-0355330. Specifically, the wire grip includes a wire grip fixing member provided with a hook, a wire winding member connected to the lower side of the wire grip fixing member and provided with a drum, a wire grip belt wound around the drum, a ratchet wheel disposed on one side of the wire winding member and coaxially connected to the drum so as to rotate the drum in only one direction, a ratchet rotatably installed on one side of the wire winding member having the ratchet wheel disposed thereon, the ratchet having one end engaged with the ratchet wheel, a handle coaxially connected to the ratchet wheel and configured to rotate the ratchet wheel and the drum, and a wire fixing member (a clip) connected to the free end side of the wire grip belt and configured to fixedly hold the wire.

However, conventional wire clips are heavy, and the usage process thereof is complicated. Therefore, it is almost impossible to use the conventional wire clips for indirect live wire work on industrial sites due to high labor intensity and limitations in physical strength. Generally, a wire is fixedly pressurized through a hinge rotation structure of a wire grip by pulling force of a wire grip belt. For this reason, since a worker needs to operate the wire grip in close proximity to the wire so as to perform wiring work, the safety of the worker is not reliably secured. Furthermore, since a worker needs to perform wiring work while directly touching the wire grip, the risk of safety incidents is significantly high.

In addition, a clip of the above-described conventional wire grip has a link structure, and durability of the clip is limited because the clip needs to withstand a significant load.

Furthermore, manual operations are repeatedly performed by a worker so as to fix and grip the wire. In this case, when direct live wire work is performed, the worker may be exposed to safety hazards, and the operation of the wire grip may be significantly inconvenient during direct live wire work. Accordingly, there are problems of worker fatigue and increase in working time.

Accordingly, in order to address the above-described problems, the applicant of the present invention has proposed an acute-angle-guide-driven wire clip for a wire grip capable of performing indirect live wire work, which is disclosed in Korean Patent No. 10-2162545.

However, the conventional wire clip has upper and lower wire grippers mounted on a guide pin. The wire grippers are configured to grip a wire and to be slidably moved along an acute guide hole. For this reason, there is a problem in that significant force is required when the wire clip is opened using a stick for indirect live wire work.

Furthermore, in the above-described wire clip, since the upper and lower wire grippers are mounted on the guide pin, rotational vibration of the wire clip may occur when tension is generated in the wire.

### RELATED ART DOCUMENT

(Patent Document 1) Korean Patent No. 10-1179056.

(Patent Document 2) Korean Utility Model No. 20-0355330.

(Patent Document 3) Korean Laid-Open Publication No. 10-2005-0065702.

(Patent Document 4) Korean Patent No. 10-2162545.

### DISCLOSURE

### Technical Problem

Therefore, the present invention has been made in view of the above problems, and it is an object of the present invention to provide a joint sliding lever link-type wire clip having an opening/closing operation grip guide function for indirect live wire work, configured to, using a stick for indirect live wire work, enable a body part of the wire clip to be slidably moved by pressing operation of an operation pin and enable a pressing gripper to perform pressing and releasing operations thereof, to easily open a gripper through indirect live wire work using the stick for indirect live wire work in a state in which a safe distance is secured between a worker and a wire, to grip the wire in proportion to the magnitude of tension of the wire, to reliably perform wire fixing work in proportion to the magnitude of tension of the wire, and to prevent safety incidents during indirect live wire work, and a wire fixing method using the same.

It is another object of the present invention to provide a joint sliding lever link-type wire clip having an opening/closing operation grip guide function for indirect live wire work, configured to enable rotation and upward/downward movement of a pressing gripper by joint sliding operation, thereby achieving improvement in durability through an improved structural configuration and reliably performing opening operation of a gripper with minimal force, and a wire fixing method using the same.

It is a further object of the present invention to provide a joint sliding lever link-type wire clip having an opening/closing operation grip guide function for indirect live wire work, configured to prevent, when a wire is fixedly gripped, rotational movement of the wire clip by a support gripper fixed to a wire clip body, and to reliably grip and fix the wire in proportion to the magnitude of tension of the wire, and a wire fixing method using the same.

### Technical Solution

In accordance with the present invention, the above and other objects can be accomplished by the provision of a wire clip coupled to a wire grip and configured to grip a wire, the wire clip including:

a wire clip body having a first shaft formed at a front upper portion thereof, a support gripper formed at a front lower portion thereof, and an opening/closing plate support pin formed at a middle upper portion thereof, the opening/closing plate support pin protruding toward a front surface of the wire clip body,

a joint sliding guider coupled to the wire clip body and configured to guide forward-and-rearward sliding movement of the wire clip body, the joint sliding guider having a wire grip coupling part formed at a rear portion thereof and a second shaft formed at an upper portion thereof,

a link part connecting the first shaft to the second shaft,

a pressing gripper formed to face the support gripper and connected to the link part by a fourth shaft so as to be moved upwards and downwards by operation of the link part, the pressing gripper having a pressing spring elastically installed in the pressing gripper and the link part such that pressing force is applied to the support gripper so as to grip and fix the wire,

an automatic opening/closing plate connected to the link part by the fourth shaft so as to be rotatably moved upwards and downwards, the automatic opening/closing plate having an opening/closing spring elastically installed in the automatic opening/closing plate and the link part so as to prevent separation of the wire gripped in a space formed between the support gripper and the pressing gripper, and

a pair of opening/closing operation grips respectively formed on a rear surface of the wire clip body and a rear surface of the joint sliding guider, the opening/closing operation grips being configured to operate the movement of the wire clip body.

The link part includes:

a rotary operation member having a central portion connected to the first shaft so as to be rotated upwards and downwards, wherein one end of a return spring surrounding the first shaft is fixed to an upper portion of the rotary operation member and the other end thereof is fixed to the wire clip body so as to provide downward rotational elasticity, and

a connection member having a rear end connected to the second shaft, the connection member having a front end formed to extend toward a front side and connected to the upper portion of the rotary operation member through a third shaft.

When the wire clip body performs joint sliding movement through guidance of the joint sliding guider, the link part performs joint movement to open and close, through upward movement and downward movement of the pressing gripper, the space formed between the support gripper and the pressing gripper and to open and close the automatic opening/closing plate.

In accordance with a further aspect of the present invention, there is provided a wire fixing method using a joint sliding lever link-type wire clip having an opening/closing operation grip guide function for indirect live wire work, wherein the joint sliding lever link-type wire clip is used to fixedly grip a wire when wire dip adjustment is performed, wire pulling work is performed to obtain an appropriate dip of the wire, wiring work is performed, or suspension insulator replacement work is performed during indirect live wire work of a distribution line, the wire fixing method including:

a work preparation step of coupling the joint sliding lever link-type wire clip to a wire grip through a wire grip coupling part,

a wire grip installation step of installing, using a stick for indirect live line work, the wire grip having the joint sliding lever link-type wire clip coupled thereto on an electric pole,

a wire fixing step of gripping and fixing, by operation of opening/closing operation grips of the joint sliding lever link-type wire clip coupled to the wire grip through the stick for indirect live line work, the wire using a support gripper of a wire clip body and a pressing gripper so as to prevent separation of the wire,

a distribution line main work step of operating the wire grip to perform the wire dip adjustment, the wire pulling work, the wiring work, or the suspension insulator replacement work,

a wire separation step of releasing, after the distribution line main work step is completed, wire fixing force of the support gripper and the pressing gripper so as to separate the joint sliding lever link-type wire clip from the wire, and

a wire grip removal step of removing the wire grip installed on the electric pole.

### Advantageous Effects

As is apparent from the above description, in a joint sliding lever link-type wire clip having an opening/closing operation grip guide function for indirect live wire work and a wire fixing method using the same, a stick for indirect live wire work is used to cause a joint sliding guider to be slidably moved by pressing operation of an operation pin, and to perform pressing and releasing operation of a pressing gripper, thereby enabling a wire to be fixedly gripped in proportion to the magnitude of tension of the wire. In this manner, in a state in which a safe distance between the wire and a worker is secured, the stick for indirect live wire work is used to easily open a gripper and to reliably grip the wire through indirect live wire work, thereby having an effect of preventing safety incidents during long-distance indirect live wire work and conveniently fixing the wire on an electric pole.

In addition, since only the pressing gripper is configured to be pressed by joint operation, durability may be further improved through the simplified structural configuration and operation, and the gripper may be opened with minimal force, thereby having an effect of achieving convenient operation and quickly and reliably performing wire fixing work.

Furthermore, a support gripper is configured to be fixed to a wire clip body, thereby having an effect of stably fixing, when the wire is fixedly gripped, the wire without movement of the wire clip.

### DESCRIPTION OF DRAWINGS

The above and other objects, features and other advantages of the present invention will be more clearly understood from the following detailed description taken in conjunction with the accompanying drawings, in which:

FIG. 1 is an exploded perspective view of a joint sliding lever link-type wire clip having an opening/closing operation grip guide function for indirect live wire work according to the present invention;

FIG. 2 is a combined perspective view of the joint sliding lever link-type wire clip having the opening/closing operation grip guide function for indirect live wire work according to the present invention;

FIG. 3 is a rear perspective view of the joint sliding lever link-type wire clip having the opening/closing operation grip guide function for indirect live wire work according to the present invention;

FIG. 4 is a cross-sectional view of a main part of a joint sliding guider of the joint sliding lever link-type wire clip having the opening/closing operation grip guide function for indirect live wire work according to the present invention;

FIG. 5 is a cross-sectional view of a main part of a link part of the joint sliding lever link-type wire clip having the opening/closing operation grip guide function for indirect live wire work according to the present invention;

FIG. 6 is view showing an open operation state of the joint sliding lever link-type wire clip having the opening/closing operation grip guide function for indirect live wire work according to the present invention;

FIG. 7 is a view showing a state in which a wire is gripped by the joint sliding lever link-type wire clip having the opening/closing operation grip guide function for indirect live wire work according to the present invention;

FIG. 8 is a view showing an overall process of a wire fixing method using the joint sliding lever link-type wire clip having the opening/closing operation grip guide function for indirect live wire work according to the present invention;

FIG. 9 is an exemplary view of a work preparation step in the wire fixing method using the joint sliding lever link-type wire clip having the opening/closing operation grip guide function for indirect live wire work according to the present invention;

FIG. 10 is another exemplary view of the work preparation step in the wire fixing method using the joint sliding lever link-type wire clip having the opening/closing operation grip guide function for indirect live wire work according to the present invention;

FIGS. 11A-11B are schematic views of a wire grip installation step in the wire fixing method using the joint sliding lever link-type wire clip having the opening/closing operation grip guide function for indirect live wire work according to the present invention;

FIG. 12 is a schematic view of the wire grip installation step in the wire fixing method using the joint sliding lever link-type wire clip having the opening/closing operation grip guide function for indirect live wire work according to the present invention;

FIG. 13 is a schematic view of a gripper opening step in a wire fixing step in the wire fixing method using the joint sliding lever link-type wire clip having the opening/closing operation grip guide function for indirect live wire work according to the present invention;

FIG. 14 is a schematic view of a wire gripping step in the wire fixing step in the wire fixing method using the joint sliding lever link-type wire clip having the opening/closing operation grip guide function for indirect live wire work according to the present invention;

FIG. 15 is an exemplary view of a distribution line main work step in the wire fixing method using the joint sliding lever link-type wire clip having the opening/closing operation grip guide function for indirect live wire work according to the present invention;

FIG. 16 is another exemplary view of the distribution line main work step in the wire fixing method using the joint sliding lever link-type wire clip having the opening/closing operation grip guide function for indirect live wire work according to the present invention;

FIG. 17 is a schematic view of a wire separation step in the wire fixing method using the joint sliding lever link-type wire clip having the opening/closing operation grip guide function for indirect live wire work according to the present invention; and

FIG. 18 is a schematic view of a wire grip removal step in the wire fixing method using the joint sliding lever link-type wire clip having the opening/closing operation grip guide function for indirect live wire work according to the present invention.

### DESCRIPTION OF REFERENCE NUMERALS

100: Wire clip body 101: First shaft
110: Support gripper 111: Wire mounting groove
112: Lower unevenness 120: Opening plate support pin
130: Guide pin 140: First guide hole
200: Joint sliding guider 201: Second shaft
210: Wire grip coupling part 211: Wire grip coupling hole
220: Second guide hole 230: Guide member
300: Link part 301: Third shaft
310: Rotary operation member 311: Return spring
320: Connection member
400: Pressing gripper 401: Fourth shaft
410: Pressing spring 420: Spring-mounted pin
430: Upper pressing groove 431: Upper unevenness
500: Automatic opening/closing plate 510: Opening/closing spring
520: Spring support pin 530: Support protrusion
600, 600′: Opening/closing operation grip 610: Ring part
S100: Work preparation step S200: Wire grip installation step
S300: Wire fixing step S310: Gripper opening step
S320: Wire gripping step S400: Distribution line main work step
S600: Wire grip removal step S500: Wire separation step

### BEST MODE

Terms or words used in the description and claims should not be restrictively interpreted as having ordinary or dictionary meanings, but should be interpreted as having meanings and concepts conforming to the inventive concept on the basis of a principle that an inventor may properly define the concept of a term to explain his or her own invention in the best way.

Therefore, embodiments described in this specification and configurations shown in the drawings are only preferred embodiments of the present invention and do not represent the entire technical idea of the present invention. It should be understood that those skilled in the art will appreciate that various modifications, additions, and substitutions are possible, without departing from the scope and spirit of the invention as disclosed in the accompanying claims.

Hereinafter, preferred embodiments of the present invention will be described in detail with reference to the attached drawings.

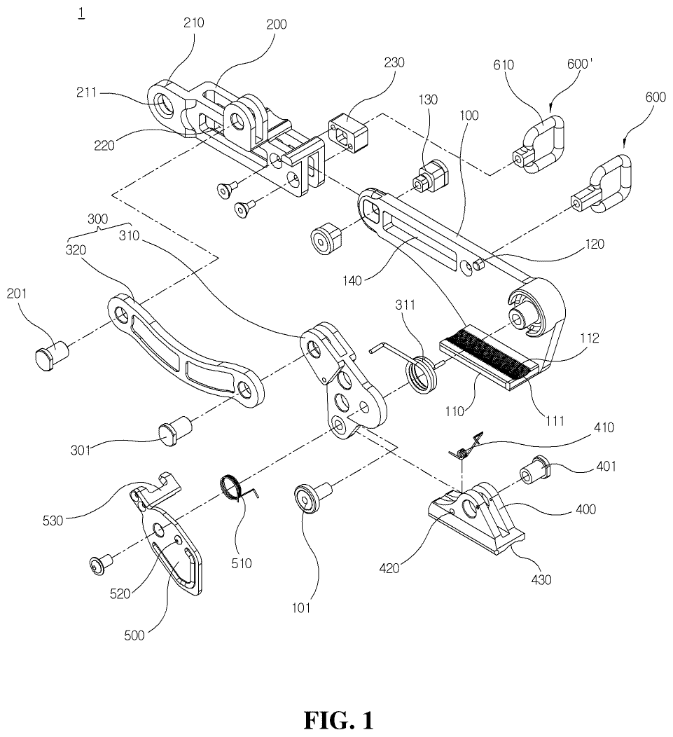

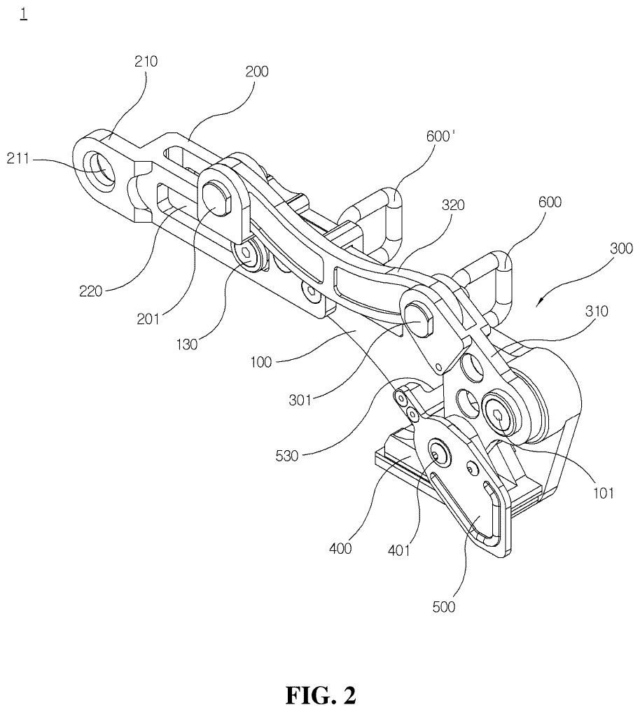

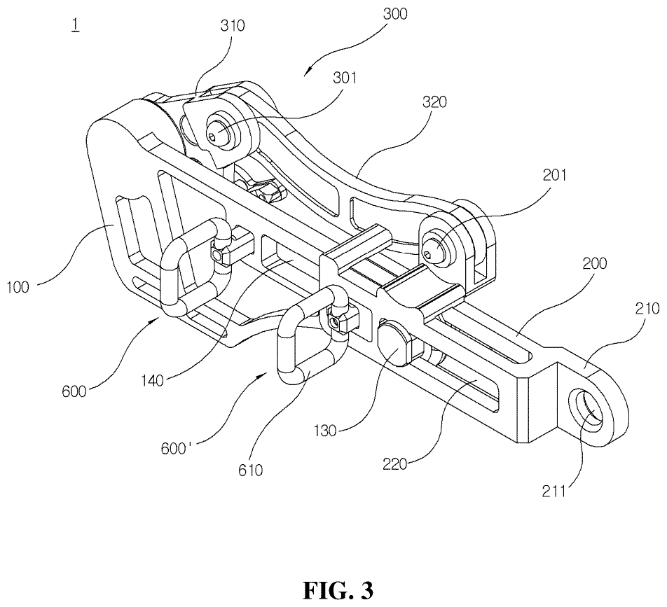

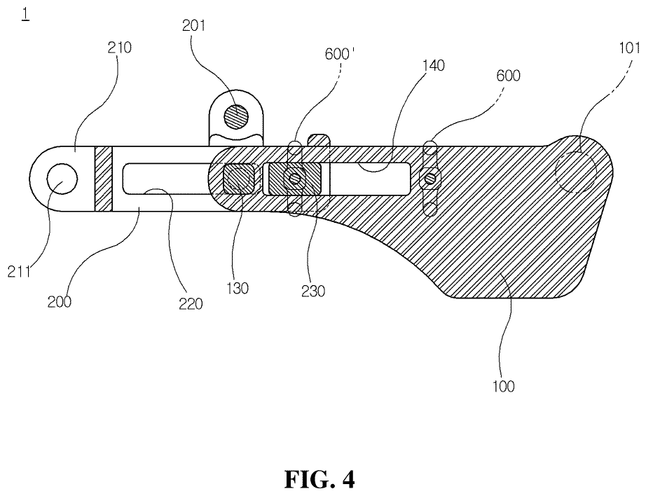

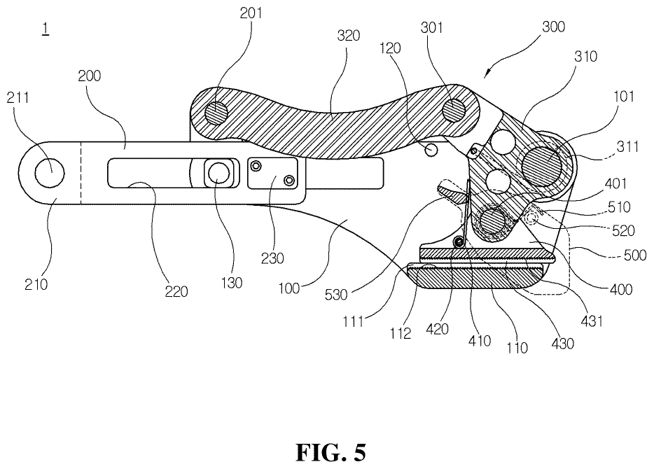

FIG. 1 is an exploded perspective view of a joint sliding lever link-type wire clip having an opening/closing operation grip guide function for indirect live wire work according to the present invention, FIG. 2 is a combined perspective view of the joint sliding lever link-type wire clip having the opening/closing operation grip guide function for indirect live wire work according to the present invention, FIG. 3 is a rear perspective view of the joint sliding lever link-type wire clip having the opening/closing operation grip guide function for indirect live wire work according to the present invention, FIG. 4 is a cross-sectional view of a main part of a joint sliding guider of the joint sliding lever link-type wire clip having the opening/closing operation grip guide function for indirect live wire work according to the present invention, and FIG. 5 is a cross-sectional view of a main part of a link part of the joint sliding lever link-type wire clip having the opening/closing operation grip guide function for indirect live wire work according to the present invention.

As shown in FIGS. 1 to 5, a joint sliding lever link-type wire clip 1 having an opening/closing operation grip guide function for indirect live wire work according to the present invention is configured such that, when a wire grip is used in various processes including a process of adjusting a dip of a wire of a distribution line in a state in which power transmission is continuously performed through the distribution line, a process of pulling the wire to obtain an appropriate dip of the wire, a process of performing wiring work, and a process of performing suspension insulator replacement work, the joint sliding lever link-type wire clip is coupled to the wire grip so as to fixedly grip the wire in proportion to the magnitude of tension of the wire. The joint sliding lever link-type wire clip 1 includes a wire clip body 100, a joint sliding guider 200, a link part 300, a pressing gripper 400, an automatic opening/closing plate 500, and opening/closing operation grips 600 and 600′.

First, the wire clip body 100 is configured to form a basic structure of the joint sliding lever link-type wire clip 1 having the opening/closing operation grip guide function for indirect live wire work according to the present invention. The wire clip body is formed to have a vertical plate-shaped block shape and extends in the forward-and-rearward direction. Here, the right side of the wire clip body in the drawing is defined as the front side.

To this end, in the wire clip body 100 of the present invention, first, a first shaft 101 is formed on the front upper portion to enable connection with the link part 300, which will be described later.

In addition, the wire clip body 100 has a support gripper 110 formed to protrude from the front lower side thereof and configured to fixedly grip a wire together with the pressing gripper 400 to be described later.

In this case, in the present invention, the support gripper 110 is formed to extend in the longitudinal direction thereof and has a semicircular groove-shaped wire mounting groove 111 formed in the upper surface thereof and configured for a wire to be mounted therein. Further, the support gripper has a sawtooth-shaped lower unevenness 112 formed on the wire mounting groove 111 and configured to prevent slippage of the gripped wire.

In addition, the wire clip body 100 has an opening/closing plate support pin 120 provided at the upper middle portion of the front side thereof and formed to protrude toward the front side of the wire clip body so as to support opening of the automatic opening/closing plate 500 to be described later.

In the configuration of the joint sliding lever link-type wire clip 1 having the opening/closing operation grip guide function for indirect live wire work according to the present invention, the joint sliding guider 200 is coupled to a wire grip and is formed to have a block shape extending in the forward-and-rearward direction. Here, the joint sliding guider is slidably coupled to the wire clip body 100 so as to guide forward-and-rearward sliding movement of the wire clip body 100.

To this end, the joint sliding guider 200 includes a wire grip coupling part 210 having a wire grip coupling hole 211 formed in the rear portion thereof.

In addition, the joint sliding guider 200 has a second shaft 201 formed at the upper portion thereof and configured to connect the first shaft 101 of the wire clip body 100 to the link part 300.

Meanwhile, in the present invention, the wire clip body 100 and the joint sliding guider 200 are configured to provide solid joint sliding without any unnecessary movement therebetween when the sliding operation is performed.

To this end, first, the wire clip body 100 has a guide pin 130 formed to penetrate the upper rear portion thereof and protrude therefrom.

Further, the wire clip body has a first guide hole 140 provided in the upper central portion thereof and formed to extend in the rear side thereof so as to form a horizontal long hole.

In addition, the joint sliding guider 200 is configured to surround the upper portion of the wire clip body 100 in a “C” shape that is open toward the lower portion of a cross section of the joint sliding guider. Further, the joint sliding guider has a horizontally long-shaped second guide hole 220 formed to penetrate the middle portion thereof and configured for the guide pin 130 to pass therethrough.

Additionally, the joint sliding guider 200 has a guide member 230 formed on the front side thereof and configured to be slidably accommodated in the first guide hole 140.

Furthermore, when pulling force is applied to the rear side of the wire clip body 100, the wire clip body is configured to be slidably moved forwards and rearwards according to guidance of the first guide hole 140 and the guide member 230 and guidance of the second guide hole 220 and the guide pin 130.

In the configuration of the joint sliding lever link-type wire clip 1 having the opening/closing operation grip guide function for indirect live wire work according to the present invention, the link part 300 is configured to connect the first shaft 101 to the second shaft 201 so as to perform a joint operation of the wire clip body 100 when the wire clip body is slidably moved, thereby performing opening/closing operation of the pressing gripper 400 and the automatic opening/closing plate 500 to be described below.

To this end, the link part 300 includes a rotary operation member 310 having a triangular shape and operating the pressing gripper 400 and the automatic opening/closing plate 500 to be described below.

In this case, the central portion of the rotary operation member 310 is connected to the first shaft 101 so as to perform joint rotation.

In addition, a return spring 311 surrounding the first shaft 101 is elastically installed on the rotary operation member 310. Here, the return spring 311 has one end fixed to the wire clip body 100 and the other end fixed to the upper portion of the rotary operation member so as to provide lower rotation elasticity.

Further, the link part 300 includes a connection member 320 that operates joint rotation of the rotary operation member 310 while the wire clip body 100 is slidably moved.

At this time, the connection member 320 is configured such that the rear end of the connection member is connected to the second shaft 201, and the front end thereof extends forwards so as to be connected to the upper portion of the rotary operation member 310 through a third shaft 301.

Meanwhile, in the present invention, the third shaft 301 connecting the rotary operation member 310 to the connection member 320 is configured to be located at a predetermined higher position than the position of the second shaft 201 in a state in which the wire clip body 100 is maximally moved forwards. Preferably, the connection member 320 performs the upward joint rotation operation thereof with the second shaft 201 as an axis of rotation when the wire clip body 100 is moved rearwards.

Accordingly, the rotary operation member 310 is configured such that, when the wire clip body 100 is moved rearwards, the connection member 320 pulls the upper portion of the rotary operation member 310 to enable the rotary operation member 310 to be rotated clockwise around the first shaft 101, thereby performing the upward joint rotation operation.

In the configuration of the joint sliding lever link-type wire clip 1 having the opening/closing operation grip guide function for indirect live wire work according to the present invention, the pressing gripper 400 opens and closes a space formed between the support gripper 110 and the pressing gripper 400 through the operation of the link part 300, thereby enabling the wire to be introduced into the space or withdrawn therefrom.

To this end, the pressing gripper 400 forms a triangular block shape and extends in the forward-and-rearward direction so as to face the support gripper 110. Further, the pressing gripper has a semicircular groove-shaped upper pressing groove 430 formed in the lower surface thereof and configured to restrict and pressurize the wire, and a sawtooth-shaped upper unevenness 431 formed in the upper pressing groove 430 and configured to prevent slippage of the gripped wire.

In this case, the upper portion of the pressing gripper 400 is connected to the lower portion of the rotary operation member 310 of the link part 300 through a fourth shaft 401 and is configured to be moved upwards and downwards by rotational operation of the rotary operation member 310, thereby opening and closing the space formed between the pressing gripper 400 and the support gripper 110.

In addition, the pressing gripper 400 has a pressing spring 410 elastically installed therein and configured to provide elastic pressure to the support gripper 110 by elastic operation of the pressure spring.

To this end, a spring-mounted pin 420 having the pressing spring 410 mounted therein is formed on the upper surface of the pressing gripper. The pressing spring 410 is configured such that one end of the pressing spring is elastically installed in the rotary operation member 310, and the other end thereof is elastically installed in the upper portion of the pressing gripper 400, thereby providing pressing elasticity through which the pressing gripper 400 is pressed toward the upper portion of the support gripper 110.

Therefore, the pressing gripper 400 is configured to overcome, when the rotary operation member 310 is rotated upwards, force of the pressing spring 410 so as to be moved upwards, thereby releasing pressing force toward the support gripper 110 and opening the space, and is configured to be moved downwards when the rotary operation member 310 is rotated downwards, thereby pressing the upper portion of the support gripper 110.

In the configuration of the joint sliding lever link-type wire clip 1 having the opening/closing operation grip guide function for indirect live wire work according to the present invention, the automatic opening/closing plate 500 is configured to prevent, by operation of the link part 300, separation of the wire gripped between the support gripper 110 and the pressing gripper 400.

To this end, the automatic opening/closing plate 500 is configured to be axially mounted on the fourth shaft 401 from the outside of the pressing gripper 400, and a spring support pin 520 is formed to protrude from the rear surface on the front side of the automatic opening/closing plate, and a support protrusion 530 is formed to protrude from the rear end of the automatic opening/closing plate.

Here, as described above, the automatic opening/closing plate 500 formed on the fourth shaft 401 is configured to provide elasticity through an opening/closing spring 510. The opening/closing spring 510 is mounted on the fourth shaft 401, one end thereof is fixed to the pressing gripper 400, and the other end thereof is supported by the spring support pin 520, so that the front side of the opening/closing spring is rotated downwards with elasticity around the fourth shaft 401.

Therefore, the automatic opening/closing plate 500 is moved downwards in conjunction with the pressing gripper 400 when the rotary operation member 310 of the link part 300 is rotated downwards, and the front side thereof is rotated downwards by elasticity of the opening/closing spring 510 so as to close the space formed between the support gripper 110 and the pressing gripper 400.

On the contrary, the rotary operation member 310 is moved in conjunction with the pressing gripper 400 during upward rotation thereof. During the above-mentioned upward movement, the automatic opening/closing plate is supported by the opening/closing plate support pin 120 when the rear support protrusion 530 comes into contact with the opening/closing plate support pin 120, and the front side thereof is rotated around the fourth shaft 401 so as to completely open the space between the support gripper 110 and the pressing gripper 400, thereby allowing the wire to be accommodated in the space.

In the configuration of the joint sliding lever link-type wire clip 1 having the opening/closing operation grip guide function for indirect live wire work according to the present invention, the opening/closing operation grips 600 and 600′ are configured to control the operation of the link part 300 through the sliding operation of the wire clip body 100 and the operation of the pressing gripper 400 and the automatic opening/closing plate 500.

To this end, the opening/closing operation grips 600 and 600′ are configured in pairs and provided on both sides. First, the opening/closing operation grip 600 on one side is disposed close to the middle portion of the wire clip body 100, that is, the front side of the first guide hole 140, and the opening/closing operation grip 600′ on the other side is disposed on the joint sliding guider 200.

Meanwhile, in the above-described configuration of the opening/closing operation grips 600 and 600′ according to the present invention, each of opening/closing operation grips has a ring part 610 formed on the tip thereof, thereby enabling various tools to be hung on the ring part.

Hereinafter, the operation of the joint sliding lever link-type wire clip having the opening/closing operation grip guide function for indirect live wire work according to the present invention will be described in detail with reference to the attached drawings.

Referring to FIGS. 1 to 5, the joint sliding lever link-type wire clip 1 having the opening/closing operation grip guide function for indirect live wire work according to the present invention enables, by joint sliding operation, simple gripping and fixing of a wire in proportion to the magnitude of tension of the wire using minimal force, and particularly, prevents movement of the gripped wire to secure stable fixing of the wire.

To this end, when the wire is gripped by using the joint sliding lever link-type wire clip 1 having the opening/closing operation grip guide function for indirect live wire work according to the present invention, the pressing gripper 400 is separated from the support gripper 110 to secure space therebetween, thereby enabling gripping of a wire 20 in proportion to the magnitude of tension of the wire.

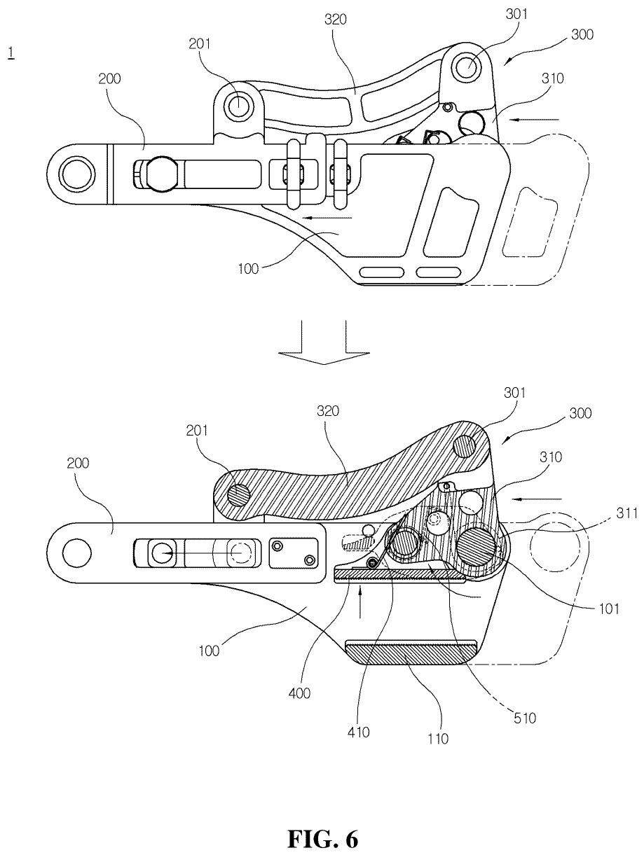

Referring to FIG. 6, the gripping of the wire is possible by operation of the opening/closing operation grips 600 and 600′. Specifically, in a state in which a general stick for indirect live wire work (not shown in the drawing) is used to hold the opening/closing operation grips 600 and 600′ provided on both sides, the opening/closing operation grip 600 formed on the wire clip body 100 is pulled by using, as a support, the opening/closing operation grip 600′ formed on the joint sliding guider 200.

Accordingly, the link part 300 is operated, and the connection member 320 is rotated upwards around the second shaft 201. Through such a process, the rotary operation member 310 is rotated clockwise, that is, rotated upwards, with compression of the return spring 311.

In addition, when the rotary operation member 310 is rotated as described above, the lower portion of the rotary operation member 310, that is, the pressing gripper 400 and the automatic opening/closing plate 500 connected to the fourth shaft 401, are moved upwards or downwards in conjunction with compression of the pressing spring 410 and the opening/closing spring 510. Through such a process, the space between the support gripper 110 and the pressing gripper 400 is widened, thereby securing a space for accommodation of the wire 20.

Here, the automatic opening/closing plate 500 moved upwards as described above is supported by the opening/closing plate support pin 120 of the wire clip body 100 in a process in which the support protrusion 530 formed at the rear end of the automatic opening/closing plate comes into contact with the opening/closing plate support pin 120, and the front side of the automatic opening/closing plate is jointly rotated upwards with the fourth shaft 401 as an axis of rotation. Accordingly, the space between the support gripper 110 and the pressing gripper 400 is fully opened.

Here, as described above, the wire 20 is accommodated in the opened space between the support gripper 110 and the pressing gripper 400, and then pulling force of the opening/closing operation grip 600 is released.

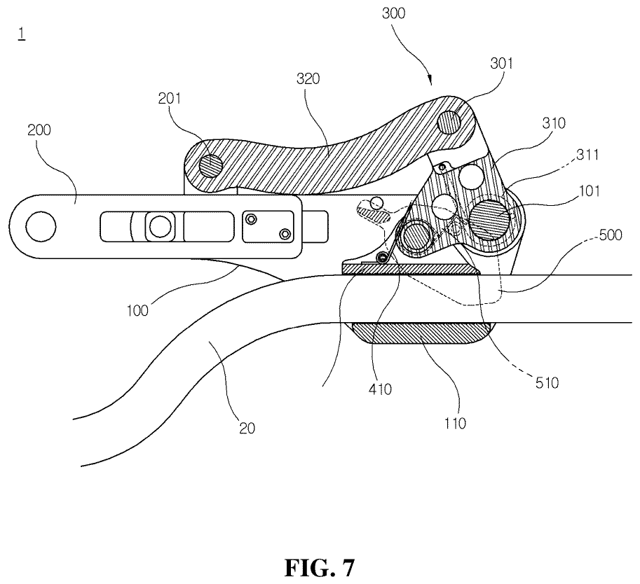

That is, referring to FIG. 7, when pulling force of the opening/closing operation grip 600 is released, the rotary operation member 310 of the link part 300 is rotated downwards counterclockwise by return elasticity of the return spring 311, and the pressing gripper 400 is moved downwards to fixedly grip the wire 20, thereby reliably fixing and gripping the wire 20 by elasticity of the pressing spring 410.

In this case, when the pressing gripper 400 grips the wire 20, the wire 20 may be stably accommodated and fixed in the space between the wire mounting groove 111 in the support gripper 110 and the upper pressing groove 430 in the pressing gripper 400.

In addition, as described above, when the rotary operation member 310 is rotated downwards, the automatic opening/closing plate 500 is also moved downwards. Here, when the automatic opening/closing plate 500 is released from support force of the opening/closing plate support pin 120, the front side of the automatic opening/closing plate is rotatably moved downwards around the fourth shaft 401 by elastic operation of the opening/closing spring 510, thereby closing the space between the support gripper 110 and the pressing gripper 400 where the wire 20 is gripped. In this manner, it is possible to prevent separation of the wire 20 from the space.

That is, the joint sliding lever link-type wire clip 1 having the opening/closing operation grip guide function for indirect live wire work according to the present invention makes it possible to fixedly grip, by sliding operation of the wire clip body 100 and joint operation of the link part 300, the wire through upward/downward movement of the pressing gripper 400 in proportion to the magnitude of tension of the wire. Particularly, a worker may stably perform the above-described operation with minimal force.

Hereinafter, a wire fixing method using the joint sliding lever link-type wire clip having the opening/closing operation grip guide function for indirect live wire work according to the present invention having the above-described configuration will be described in detail with reference to the attached drawings.

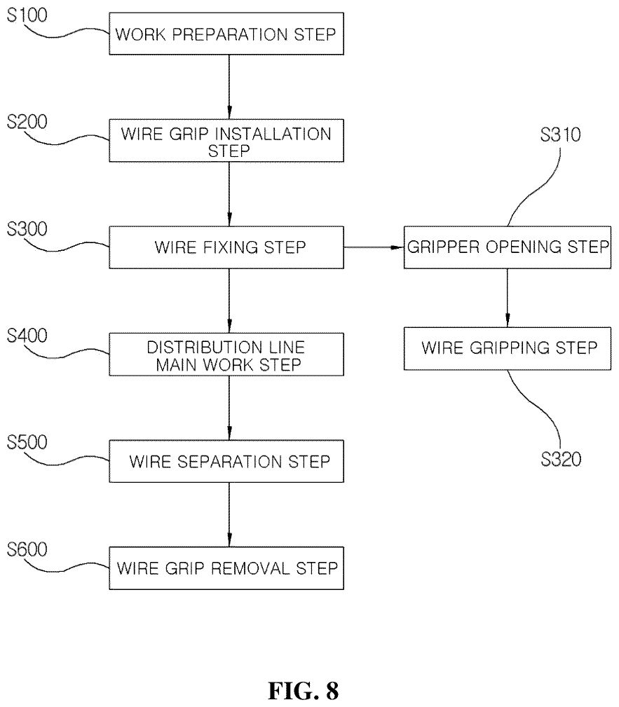

FIG. 8 is a view showing an overall process of the wire fixing method using the joint sliding lever link-type wire clip having the opening/closing operation grip guide function for indirect live wire work according to the present invention.

Referring to FIGS. 1 to 7, in the wire fixing method using the joint sliding lever link-type wire clip having the opening/closing operation grip guide function for indirect live wire work according to the present invention, when a wire grip is used to fix a wire during various processes including a process of adjusting a dip of a wire of a distribution line, a process of pulling the wire to obtain an appropriate dip of the wire, a process of performing wiring work, and a process of performing suspension insulator replacement work, the wire may be simply gripped and fixed in proportion to the magnitude of tension of the wire through indirect live wire work, as shown in FIG. 8. The wire fixing method is performed through a work preparation step S100, a wire grip installation step S200, a wire fixing step S300, a distribution line main work step S400, a wire separation step S500, and a wire grip removal step S600.

First, in the work preparation step S100, in order to perform the wire fixing method using the joint sliding lever link-type wire clip having the opening/closing operation grip guide function for indirect live wire work according to the present invention, the joint sliding lever link-type wire clip 1 having the opening/closing operation grip guide function for indirect live wire work is prepared.

To this end, the prepared joint sliding lever link-type wire clip 1 having the opening/closing operation grip guide function for indirect live wire work is not limited, and any type of wire clip may be prepared depending on the field conditions. For example, the wire clip 1 may be prepared in a state of being coupled to a conventional wire grip 10.

Here, a method of coupling, to the wire grip 10, the joint sliding lever link-type wire clip 1 having the opening/closing operation grip guide function for indirect live wire work is not limited, and various coupling methods may be used. In the present invention, the coupling method is performed by a wire grip coupling part 210.

Meanwhile, the present invention is not limited to the wire grip 10 to which the joint sliding lever link-type wire clip 1 having the opening/closing operation grip guide function for indirect live wire work is coupled. For example, another type of wire grip may be employed as long as the wire grip has a structure including a hook 12 formed on one side of a wire grip body 11 and configured to be installed on an arm-shaped support member of an electric pole, a connector 14 formed on the other side of the body 11 and configured for a belt 13 wound around the body 11 to pass therethrough, and the like, as in a wire grip 10 disclosed in Korean patent No. 10-1984829, Korean patent No. 10-2161405, and Korean patent No. 10-2447795 proposed by the applicant of the present invention.

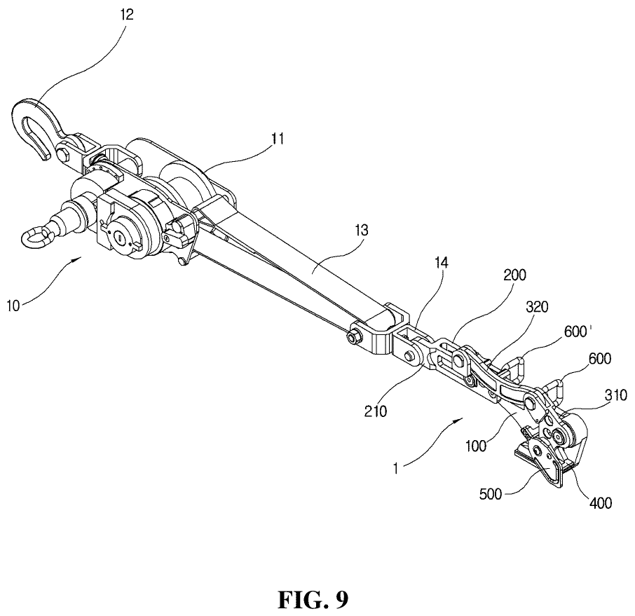

Here, in the embodiment, first, referring to FIG. 9, the joint sliding lever link-type wire clip 1 having the opening/closing operation grip guide function for indirect live wire work according to the present invention is coupled to the connector 14 using the wire grip coupling part 210 in a state in which the hook 12 is connected to the wire grip body 11.

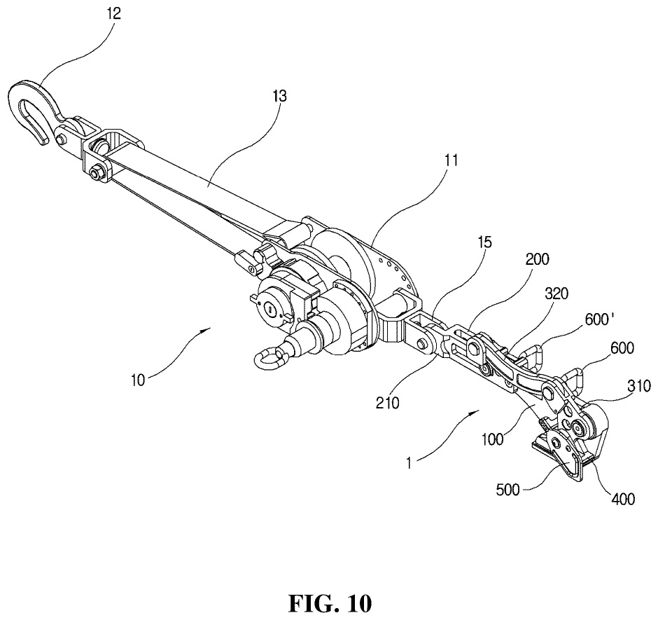

In addition, referring to FIG. 10, the joint sliding lever link-type wire clip 1 having the opening/closing operation grip guide function for indirect live wire work according to the present invention may be coupled to the wire grip body 11 by using a separate connector 15 and the wire grip coupling part 210 in a state in which the hook 12 of the wire grip 10 is connected to a wire grip belt 13.

That is, in the work preparation step S100, the joint sliding lever link-type wire clip 1 having the opening/closing operation grip guide function for indirect live wire work according to the present invention may be coupled to the wire grip 10 and may be applied in various ways depending on work environment conditions regardless of the direction of the wire grip 10.

Further, the joint sliding lever link-type wire clip 1 having the opening/closing operation grip guide function for indirect live wire work may hang on a general arm-shaped support member and a usable rope (not shown in the drawing). In this manner, the wire clip 1 may be prepared as a single unit.

Thereafter, in the wire grip installation step S200, in order to perform the wire fixing method using the joint sliding lever link-type wire clip having the opening/closing operation grip guide function for indirect live wire work according to the present invention, as described above, the wire grip 10 coupled to the joint sliding lever link-type wire clip 1 having the opening/closing operation grip guide function for indirect live wire work is installed on an electric pole (not shown in the drawing) so as to adjust a dip of the wire, pull the wire to obtain an appropriate dip of the wire, perform wiring work, and perform suspension insulator replacement work.

To this end, a method of installing, on the electric pole, the wire grip 10 coupled to the joint sliding lever link-type wire clip 1 having the opening/closing operation grip guide function for indirect live wire work is not limited. Various installation methods may be used depending on the field conditions.

Accordingly, as an example, in a state in which the joint sliding lever link-type wire clip 1 having the opening/closing operation grip guide function for indirect live wire work prepared as described in the above embodiment is coupled to the wire grip 10, the wire grip 10 is installed on the electric pole (not shown in the drawing) so as to adjust a dip of the wire, pull the wire to obtain an appropriate dip of the wire, perform wiring work, and perform suspension insulator replacement work.

Meanwhile, in the present invention, when the wire grip 10 is mounted on an arm-shaped support member 21, the wire grip may be installed on the electric pole using the hook 12 of the wire grip regardless of a direction in which the wire clip 1 is coupled to the wire grip 10.

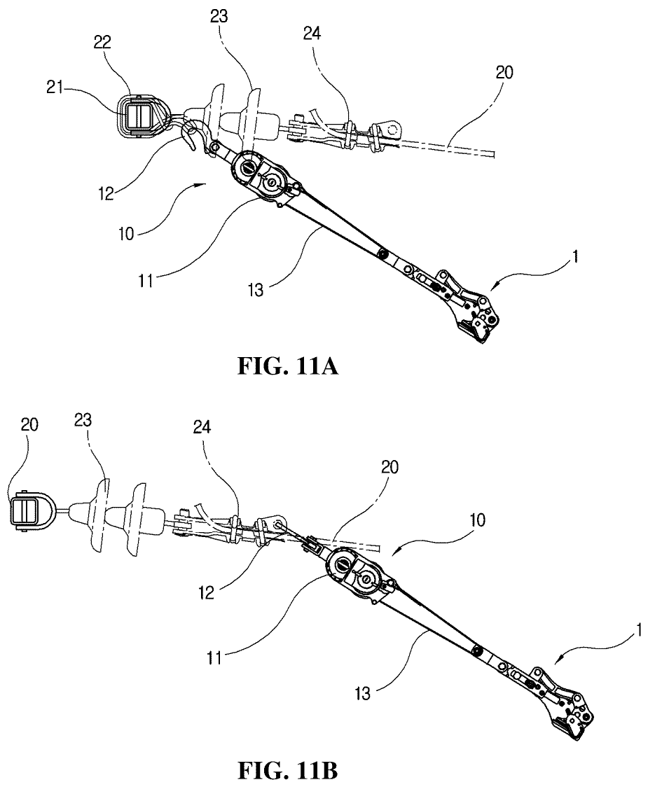

In this case, in the present invention, a method of installing the wire grip 10 on the electric pole is not limited, and various installation methods may be used. For example, the wire grip may be installed on the electric pole by hanging the hook 12 on a rope 22 installed on the arm-shaped support member 21, as shown in FIG. 11A, or by hanging the hook on a dead end clamp 24 connected to a suspension insulator 23, as shown in FIG. 11B.

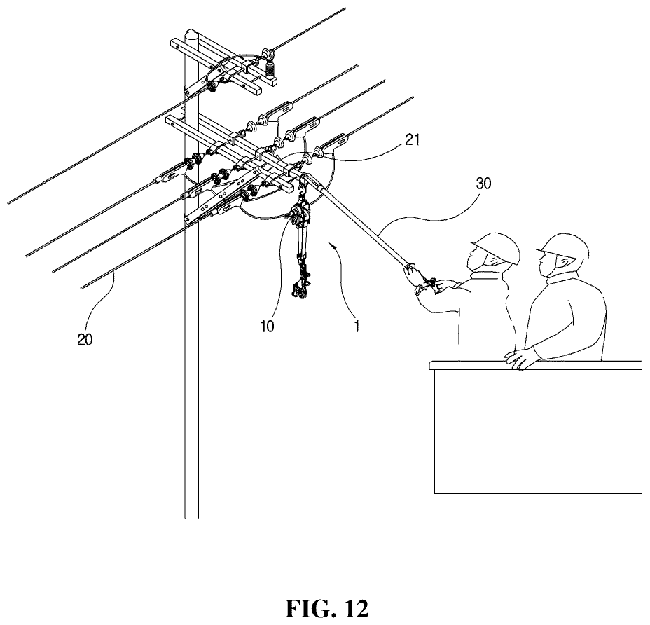

In this case, referring to FIG. 12, a worker may safely perform the above-described installation work from a long distance by using a stick 30 for indirect live wire work in a state in which the worker approaches the vicinity of the wire 20 on the electric pole while securing a safe distance between the worker and the wire by using a bucket for indirect live wire work.

Meanwhile, the stick 30 for indirect live work, which is employed in the present invention, is not limited, and various type of sticks 30 for indirect live work may be employed. In the embodiment of the present invention, a plier stick disclosed in Korean Patent No. 10-2021001, Korean Patent No. 10-1963537, and Korean Patent No. 10-1963539, or a grip all clamp stick disclosed in Korean Patent No. 10-2028010, invented by the applicant of the present invention, may be employed.

Thereafter, in the wire fixing step S300, in order to perform the wire fixing method using the joint sliding lever link-type wire clip having the opening/closing operation grip guide function for indirect live wire work according to the present invention, as described above, the joint sliding lever link-type wire clip 1 having the opening/closing operation grip guide function for indirect live wire work, which is installed on the wire grip 10, is used to hold and fix the wire 20 so as to adjust a dip of the wire, pull the wire to obtain an appropriate dip of the wire, perform wiring work, and perform suspension insulator replacement work through indirect live wire work.

To this end, first, a gripper opening step S310 is performed to open a space formed between the support gripper 110 and the pressing gripper 400.

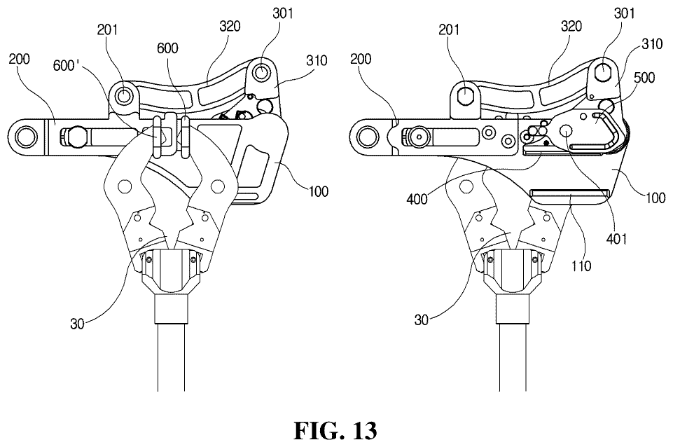

Here, in the gripper opening step S310, referring to FIG. 6, the worker uses the stick 30 for indirect live work so as to pull the opening/closing operation grip 600 of the wire clip body 100 toward one side with the opening/closing operation grip 600′ formed on the joint sliding guider 200 as the support side, as shown in FIG. 13. Then, the wire clip body 100 is slidably moved rearwards through guidance of the guide member 230 of the joint sliding guider 200 and the first guide hole 140.

At this time, the moving wire clip body 100 is moved rearwards together with the rotary operation member 310 of the link part 300 connected to the first shaft 101. Accordingly, as a gap between the first shaft 101 and the second shaft 201 is reduced, the connection member 320 connected to the third shaft 301 is pushed upwards with the second shaft 201 as the axis, and the rotary operation member 310 is rotatably moved upwards.

In addition, when the rotary operation member 310 is rotated upwards as described above, the lower portion of the rotary operation member 310, that is, the pressing gripper 400 and the automatic opening/closing plate 500 connected to the fourth shaft 401, are moved upwards together with compression of the pressing spring 410 and the opening/closing spring 510. In this process, a space between the support gripper 110 and the pressing gripper 400 is widened, thereby securing a space for accommodation of the wire 20.

In this case, the automatic opening/closing plate 500 moved upwards as described above is supported by the opening/closing plate support pin 120 while the support protrusion 530 formed at the rear end of the automatic opening/closing plate is in contact with the opening/closing plate support pin 120 of the wire clip body 100, and the front side of the automatic opening/closing plate is rotatably moved upwards with the fourth shaft 401 as an axis of rotation. Therefore, the space between the support gripper 110 and the pressing gripper 400 is fully opened.

Thereafter, the wire gripping step S320 is performed to fixedly grip the wire 20 by reducing the space between the support gripper 110 and the pressing gripper 400, which is a secured space for accommodation of the wire 20 as described above.

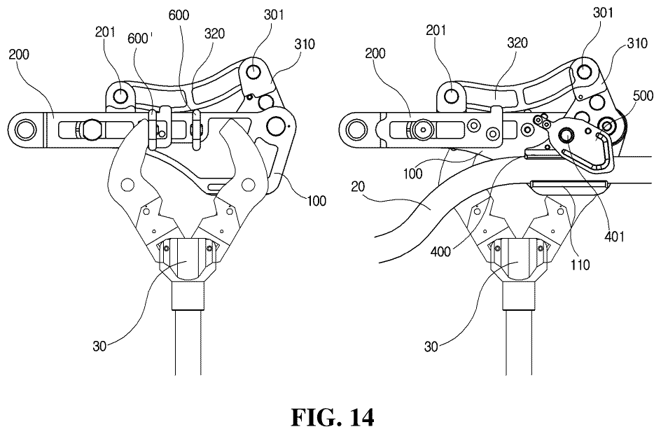

Here, in the wire gripping step S320, in a state in which the stick 30 for indirect live work is used to grip the opening/closing operation grips 600 and 600′ and the wire 20 is accommodated in the space between the support gripper 110 and the pressing gripper 400, referring to FIG. 7, the worker release, from a long distance, external pulling force of the opening/closing operation grip 600 formed on the wire clip body 100, as shown in FIG. 14.

Therefore, the rotary operation member 310 of the link part 300 is rotated downwards by return elasticity of the return spring 311. In this case, the pressing gripper 400 connected to the lower portion of the rotary operation member 310 is also moved downwards, and the pressing gripper 400 presses the upper portion of the wire 20 by elasticity of the pressing spring 410 so as to firmly grip and fix the wire in the space between the support gripper 110 and the pressing gripper 400.

In addition, as described above, the wire 20 is accommodated in the opened space between the support gripper 110 and the pressing gripper 400, and then pulling force of the opening/closing operation grip 600 is released.

That is, when pulling force of the opening/closing operation grip 600 is released, the rotary operation member 310 of the link part 300 is rotated downwards counterclockwise by return elasticity of the return spring 311. Accordingly, the pressing gripper 400 is moved downwards to grip and fix the wire 20. In this manner, the wire 20 is firmly gripped and fixed by elasticity of the pressing spring 410.

Here, when the pressing gripper 400 grips the wire 20, the wire 20 is stably accommodated and fixed in the space formed between the wire mounting groove 111 in the support gripper 110 and the upper press groove 430 in the pressing gripper 400, and the wire 20 gripped and fixed in the space is able to be firmly gripped without slippage thereof by the upper unevenness 431 and the lower unevenness 112 respectively formed in the upper pressing groove 430 and the wire mounting groove 111.

Meanwhile, when the rotary operation member 310 is rotated downwards as described above, the automatic opening/closing plate 500 is also moved downwards. Further, when the automatic opening/closing plate 500 is released from support force of the opening/closing plate support pin 120, the front side thereof is rotated downwards around the fourth shaft 401 by elastic operation of the opening/closing spring 510. Accordingly, the space formed between the support gripper 110 and the pressing gripper 400 and configured for the wire 20 to be gripped therein is closed, thereby completely preventing separation of the wire 20.

Thereafter, in the distribution line main work step S400, in order to perform the wire fixing method using the joint sliding lever link-type wire clip having the opening/closing operation grip guide function for indirect live wire work according to the present invention, as described above, the joint sliding lever link-type wire clip 1 having the opening/closing operation grip guide function for indirect live wire work, which is installed on the wire grip 10, is used to adjust a dip of the wire, pull the wire to obtain an appropriate dip of the wire, perform wiring work, and perform suspension insulator replacement work through indirect live wire work.

At this time, when the main work of the distribution line is performed as described above, the main work may be performed in various ways depending on the work environment conditions.

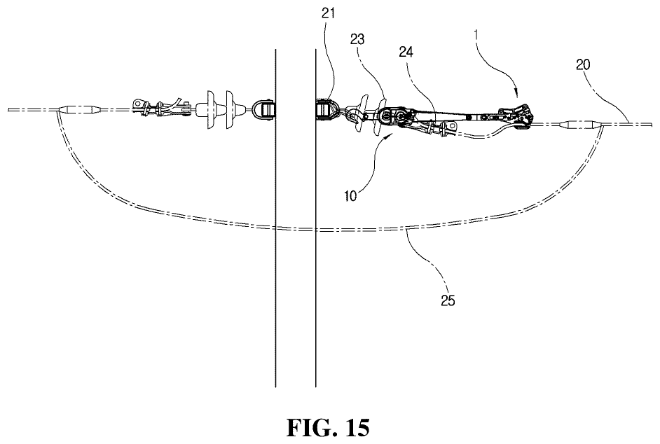

To this end, first, referring to FIG. 15, when wire dip adjustment, wire pulling work, wiring work, or suspension insulator replacement work is performed, in a general electric pole, indirect live wire work may be performed for the main work in a state in which the wires 20 respectively disposed on the opposite sides of the electric pole are connected to each other using a jumper wire 25 such that power transmission is performed through the wires.

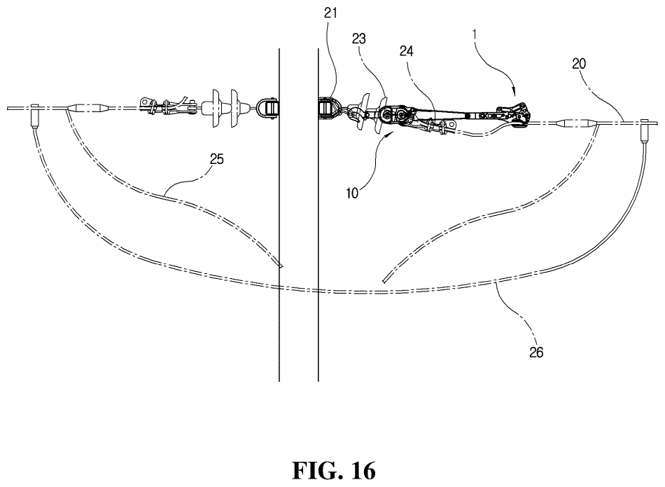

In addition, referring to FIG. 16, when indirect live wire work is performed to adjust a dip of the wire, pull the wire to obtain an appropriate dip of the wire, perform wiring work, or perform suspension insulator replacement work, uninterruptible power wiring work may be performed through indirect live wire work in a state in which, in a general electric pole, the jumper wire 25 connecting the wires 20 respectively disposed on the opposite sides of the electric pole is cut, and the wires respectively disposed on the opposite sides of the electric pole are connected to each other by a bypass jumper cable 26.

Meanwhile, in the embodiment of the distribution line main work according to the present invention, the distribution line main work has been described as an example of wire dip adjustment, wire pulling work, wiring work, or suspension insulator replacement work, but the present invention is not limited thereto. It is obvious that various types of work may be performed to grip a wire using the joint sliding lever link-type wire clip 1 having the opening/closing operation grip guide function for indirect live wire work during the indirect live wire work of the distribution line.

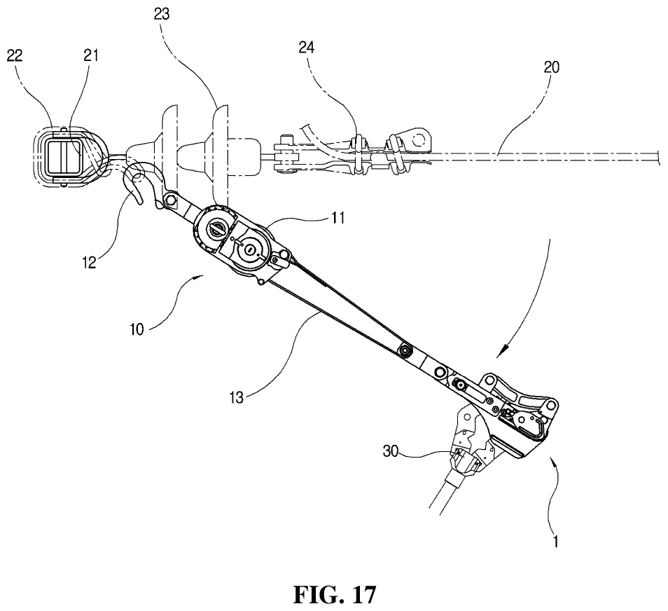

Thereafter, in the wire separation step S500, referring to FIG. 17, after the indirect live wire work is performed as described above, fixing force of the support gripper 110 and the pressing gripper 400, which is applied to the wire 20, is released to separate, from the wire 20, the joint sliding lever link-type wire clip 1 having the opening/closing operation grip guide function for indirect live wire work according to the present invention.

Referring to FIG. 13, as in the gripper opening step S310 in the wire fixing step S300, the stick 30 for indirect live wire work is used to pull the opening/closing operation grip 600 of the wire clip body 100 toward one side with the opening/closing operation grip 600′ formed on the joint sliding guider 200 as the support side, thereby allowing the pressing gripper 400 to be moved upwards and releasing gripping force applied to the wire 20.

In this case, as described above, when the pressing gripper 400 is moved upwards, the automatic opening/closing plate 500 is also moved upwards such that the front side thereof is rotated upwards, thereby fully opening the space formed between the support gripper 110 and the pressing gripper 400. In this manner, the wire 20 may be freely moved in the space.

Afterwards, as described above, in a state in which the opening/closing operation grip 600 is pulled toward one side so as to fully open the space between the support gripper 110 and the pressing gripper 400, the joint sliding lever link-type wire clip 1 having the opening/closing operation grip guide function for indirect live wire work is separated from the wire 20.

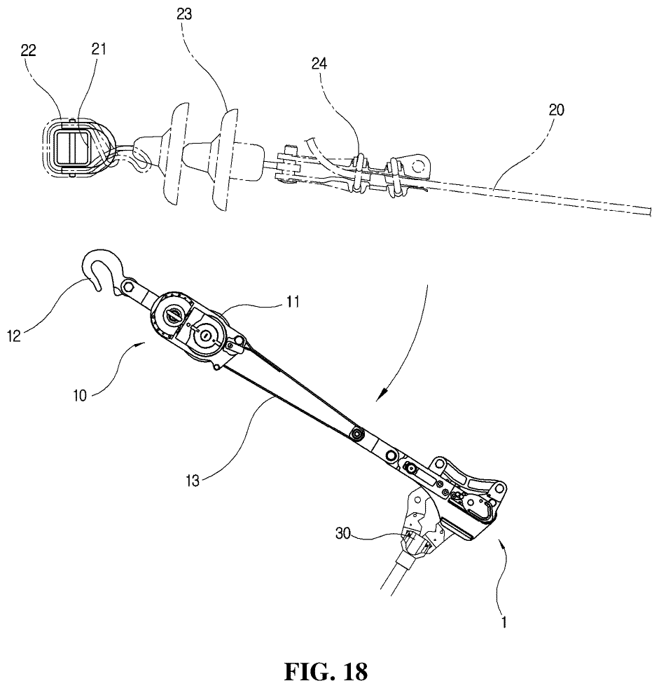

Thereafter, in the wire grip removal step S600, referring to FIG. 18, in order to perform the wire fixing method using the joint sliding lever link-type wire clip having the opening/closing operation grip guide function for indirect live wire work according to the present invention, as described above, the wire grip 10 is removed in a state in which the joint sliding lever link-type wire clip 1 having the opening/closing operation grip guide function for indirect live wire work is separated from the wire 20. Here, referring to FIG. 12, a worker may safely perform, using the stick 30 for indirect live wire work, wire grip removal work from a long distance in a state in which the worker approaches the vicinity of the wire 20 on the electric pole while securing a safe distance between the worker and the wire by using the bucket for indirect live wire work.

Accordingly, through the wire fixing method using the joint sliding lever link-type wire clip 1 having the opening/closing operation grip guide function for indirect live wire work, the wire may be fixedly gripped in proportion to the magnitude of the tension of the wire during the indirect live line work.

As described above, in the joint sliding lever link-type wire clip having the opening/closing operation grip guide function for indirect live wire work according to the present invention and the wire fixing method using the same, the wire clip may be coupled to a wire grip so as to perform various processes including a process of adjusting a dip of a wire, a process of pulling the wire to obtain an appropriate dip of the wire, a process of performing wiring work, and a process of performing suspension insulator replacement work. Particularly, in the process of fixedly gripping the wire, it is possible to easily and quickly grip and fix the wire from a long distance using a stick for indirect live wire work in a state in which a safe distance between a worker and the wire through which power transmission is performed is secured. In this manner, the wire may be stably fixed without separation from the wire clip.

### Industrial Applicability

According to the present invention, in a joint sliding lever link-type wire clip having an opening/closing operation grip guide function for indirect live wire work and a wire fixing method using the same, a stick for indirect live wire work is used to easily open a gripper and reliably grip a wire in a state in which a safe distance between the wire and a worker is secured, thereby having an effect of preventing safety incidents during long-distance indirect live wire work and conveniently fixing the wire on an electric pole. In addition, durability may be further improved through a simplified structural configuration and operation, and the gripper may be opened with minimal force, thereby having an effect of achieving convenient operation and quick and reliable wire fixing work. Furthermore, when the wire is fixedly gripped, the wire may be stably gripped and fixed without movement of the wire.

1. A joint sliding lever link-type wire clip having an opening/closing operation grip guide function for indirect live wire work, the joint sliding lever link-type wire clip being coupled to a wire grip and being configured to grip a wire, the joint sliding lever link-type wire clip comprising:
a wire clip body (100) having a first shaft (101) formed at a front upper portion thereof, a support gripper (110) formed at a front lower portion thereof, and an opening/closing plate support pin (120) formed at a middle upper portion thereof, the opening/closing plate support pin protruding toward a front surface of the wire clip body;
a joint sliding guider (200) coupled to the wire clip body (100) and configured to guide forward-and-rearward sliding movement of the wire clip body (100), the joint sliding guider having a wire grip coupling part (210) formed at a rear portion thereof and a second shaft (201) formed at an upper portion thereof;
a link part (300) connecting the first shaft (101) to the second shaft (201);
a pressing gripper (400) formed to face the support gripper (110) and connected to the link part (300) by a fourth shaft (401) so as to be moved upwards and downwards by operation of the link part (300), the pressing gripper having a pressing spring (410) elastically installed in the pressing gripper and the link part (300) such that pressing force is applied to the support gripper (110) so as to grip and fix the wire;
an automatic opening/closing plate (500) connected to the link part (300) by the fourth shaft (401) so as to be rotatably moved upwards and downwards, the automatic opening/closing plate having an opening/closing spring (510) elastically installed in the automatic opening/closing plate and the link part (300) so as to prevent separation of the wire gripped in a space formed between the support gripper (110) and the pressing gripper (400); and
a pair of opening/closing operation grips (600) and (600′) respectively formed on a rear surface of the wire clip body (100) and a rear surface of the joint sliding guider (200), the opening/closing operation grips being configured to operate the movement of the wire clip body (100),
wherein the link part (300) comprises:
a rotary operation member (310) having a central portion connected to the first shaft (101) so as to be rotated upwards and downwards, wherein one end of a return spring (311) surrounding the first shaft (101) is fixed to an upper portion of the rotary operation member and the other end thereof is fixed to the wire clip body (100) so as to provide downward rotational elasticity; and
a connection member (320) having a rear end connected to the second shaft (201), the connection member having a front end formed to extend toward a front side and connected to the upper portion of the rotary operation member (310) through a third shaft (301), and
wherein, when the wire clip body (100) performs joint sliding movement through guidance of the joint sliding guider (200), the link part (300) performs joint movement to open and close, through upward movement and downward movement of the pressing gripper (400), the space formed between the support gripper (110) and the pressing gripper and to open and close the automatic opening/closing plate (500).

2. The joint sliding lever link-type wire clip according to claim 1, wherein the wire clip body (100) has a guide pin (130) configured to pass through a rear upper portion thereof forwards and rearwards, and a first guide hole (140) formed to pass through an upper central portion of the wire clip body, the first guide hole extending toward a rear side of the wire clip body, and
wherein the joint sliding guider (200) surrounds an upper portion of the wire clip body (100) and has a horizontally long-shaped second guide hole (220) and a guide member (230), the second guide hole being formed to pass through a middle portion of the joint sliding guider and being configured for the guide pin (130) to pass therethrough, the guide member being formed on a front side of the joint sliding guider and being slidably moved along the first guide hole (140).

3. The joint sliding lever link-type wire clip according to claim 1, wherein the pressing gripper (400) has a spring-mounted pin (420) formed for the pressing spring (410) to be mounted thereon, and
wherein one end of the pressing spring (410) is configured to be elastically installed in the rotary operation member (310), and the other end thereof is configured to be elastically installed in the pressing gripper (400), thereby providing elasticity allowing the pressing gripper (400) to press an upper portion of the support gripper (110).

4. The joint sliding lever link-type wire clip according to claim 1, wherein the support gripper (110) is configured to have a semicircular groove-shaped wire mounting groove (111) formed in an upper surface thereof and configured for the wire to be mounted therein, the wire mounting groove having lower unevenness (112) formed thereon and configured to prevent slippage of the wire, and
wherein the pressing gripper (400) is configured to have a semicircular groove-shaped upper pressing groove (430) formed in a lower surface thereof and configured for the wire to be mounted therein, the upper pressing groove having upper unevenness (431) formed thereon and configured to prevent slippage of the wire.

5. The joint sliding lever link-type wire clip according to claim 1, wherein the automatic opening/closing plate (500) is located on an outer side of the pressing gripper (400) and is configured to be axially mounted on the fourth shaft (401), the automatic opening/closing plate having a spring support pin (520) formed on a front side thereof and a support protrusion (530) formed on a rear end thereof,
wherein the opening/closing spring (510) is mounted on the fourth shaft (401), one end of the opening/closing spring is fixed to the pressing gripper (400), and the other end thereof is supported by the spring support pin (520) such that a front side of the automatic opening/closing plate (500) is configured to have downward rotational elasticity around the fourth shaft (401),
wherein, when the automatic opening/closing plate (500) is moved downwards, a front side of the automatic opening/closing plate is configured to be rotated downwards around the fourth shaft (401) by elasticity of the opening/closing spring (510) so as to close the space between the support gripper (110) and the pressing gripper (400), and
wherein, when the automatic opening/closing plate is moved upwards, the support protrusion (530) is configured to be supported by the opening/closing plate support pin (120), and the front side of the automatic opening/closing plate is configured to be rotated upwards so as to fully open the space between the support gripper (110) and the pressing gripper (400).

6. The joint sliding lever link-type wire clip according to claim 1, wherein each of the opening/closing operation grips (600) and (600′) is configured to have a ring part (610) formed on a tip thereof.

7. A wire fixing method using a joint sliding lever link-type wire clip having an opening/closing operation grip guide function for indirect live wire work, wherein the joint sliding lever link-type wire clip according to claim 1 is used to fixedly grip a wire when wire dip adjustment is performed, wire pulling work is performed to obtain an appropriate dip of the wire, wiring work is performed, or suspension insulator replacement work is performed during indirect live wire work of a distribution line, the wire fixing method comprising:
a work preparation step (S100) of coupling the joint sliding lever link-type wire clip to a wire grip (10) through a wire grip coupling part (210);
a wire grip installation step (S200) of installing, using a stick for indirect live line work, the wire grip (10) having the joint sliding lever link-type wire clip coupled thereto on an electric pole;
a wire fixing step (S300) of gripping and fixing, by operation of opening/closing operation grips (600) and (600′) of the joint sliding lever link-type wire clip coupled to the wire grip (10) through the stick for indirect live line work, the wire using a support gripper (110) of a wire clip body (100) and a pressing gripper (400) so as to prevent separation of the wire;
a distribution line main work step (S400) of operating the wire grip to perform the wire dip adjustment, the wire pulling work, the wiring work, or the suspension insulator replacement work;
a wire separation step (S500) of releasing, after the distribution line main work step is completed, wire fixing force of the support gripper (110) and the pressing gripper (400) so as to separate the joint sliding lever link-type wire clip from the wire; and
a wire grip removal step (S600) of removing the wire grip installed on the electric pole.

8. The wire fixing method according to claim 7, wherein the wire fixing step (S300) comprises:
a gripper opening step (S310) of pulling, using the stick for indirect live wire work, the opening/closing operation grip (600) of the wire clip body (100) toward one side with the opening/closing operation grip (600′) formed on the joint sliding guider (200) as a support side so as to move the wire clip body (100) toward the wire grip (10) and operate the link part (300), thereby enabling upward movement of the pressing gripper (400) and the automatic opening/closing plate (500) and widening a space between the support gripper (110) and the pressing gripper so as to open the space therebetween; and
a wire gripping step (S320) of releasing, in a state in which the wire is accommodated in the opened space between the support gripper (110) and the pressing gripper (400), pulling external force of the opening/closing operation grip (600) to allow the pressing gripper (400) to be moved downwards by elastic operation of a return spring (311) of the link part (300) and a pressing spring (410) of the pressing gripper (400) and to fixedly press the wire by the pressing gripper (400), and allowing the automatic opening/closing plate (500) to be rotatably moved downwards by elastic operation of an opening/closing spring (510) to close the space formed between the support gripper (110) and the pressing gripper (400) and to prevent separation of the wire.

9. The wire fixing method according to claim 7, wherein, in the distribution line main work step (S400), the wire dip adjustment, the wire pulling work, the wiring work, or the suspension insulator replacement work is performed through live wire work.

10. The wire fixing method according to claim 7, wherein, in the distribution line main work step (S400), the wire dip adjustment, the wire pulling work, the wiring work, or the suspension insulator replacement work is performed through uninterruptible power wiring work.
